(19) United States
(12) Patent Application Publication
(10) Pub. No.: US 2011/0083862 A1
(43) Pub. Date: Apr. 14, 2011

(54) Apparatus for Restraining a Cylindrical Object

(76) Inventor: Jeremy Starr, Indianapolis, IN (US)

(21) Appl. No.: 12/900,321

(22) Filed: Oct. 7, 2010

Related U.S. Application Data
(60) Provisional application No. 61/249,523, filed on Oct. 7, 2009.

(51) Int. Cl. A62C 13/78

(52) U.S. Cl. 169/51

(57) ABSTRACT

An apparatus for restraining a cylindrical object may include a frame having a base configured to receive one end of the cylindrical object and a top opposite the base, a first web mounted to the frame and having a free end configured to extend over at least a portion of an opposite end of the cylindrical object when the cylindrical object is received in the frame and a second web mounted to the frame having a free end configured to extend over at least another portion of the opposite end of the cylindrical object when the cylindrical object is received in the frame. One or more suitable structures are provided for engaging the free ends of the first and second webs with the frame to thereby restrain the cylindrical object relative to the frame.

### CROSS-REFERENCE TO RELATED PATENT APPLICATION

This patent application claims priority to, and the benefit of, U.S. Provisional Patent Application Ser. No. 61/249,523, filed Oct. 7, 2009, the disclosure of which is incorporated herein by reference.

### FIELD OF THE INVENTION

The present invention relates generally to restraint systems for cylindrical objects, and more specifically to apparatuses for restraining cylinders within or on, for example, but not limited to, motor vehicles.

### BACKGROUND

Conventional cylindrical object restraining systems are configured to restrain lateral cylinder motion. Some such restraining systems may further be configured to restrain vertical cylinder motion in one direction. It is desirable to provide a cylindrical object restraining system that restrains cylinder motion in all directions such that the cylindrical object may be mounted via the cylindrical object restraining system to a support structure with any desired orientation of the cylindrical object relative to the support structure.

### SUMMARY

The present invention may comprise one or more of the features recited in the attached claims, and/or one or more of the following features and combinations thereof. An apparatus for restraining a cylindrical object may comprise a frame having a base configured to receive in contact one end of the cylindrical object and a top opposite the base, a first web mounted to the frame at or near the top thereof and having a free end extending over at least a portion of an opposite end of the cylindrical object when the cylindrical object is received in the frame, a second web mounted to the frame at or near the top thereof and having a free end extending over at least another portion of the opposite end of the cylindrical object when the cylindrical object is received in the frame, a third web mounted to the frame at or near the base thereof and having a free end, and means for releasably engaging the free ends of the first, second and third webs to thereby restrain the cylindrical object relative to the frame.

The frame may comprise a rigid, elongated frame member having a top that defines the top of the frame and a bottom opposite the top of the elongated frame member. The base of the frame may comprise a base member that extends outwardly and away from the bottom of the elongated frame member to a free end thereof. The base member may be configured to receive in contact the one end of the cylindrical object when the cylindrical object is received in the frame. The base member may define opposing sides between the elongated frame member and the free end thereof. The apparatus may further comprise a first ear extending upwardly from one of the opposing sides of the base member, and a second ear extending upwardly from the other of the opposing sides of the base member. The first and second ears may be configured to restrain sideways movement of the one end of the cylindrical object relative to the base member when the cylindrical object is received in the frame. The apparatus may further comprise means for adjusting a distance between the first and second ears to accommodate cylindrical objects of different diameters.

The first web and the second web may together comprise a single length of web having one end defining the free end of the first web and an opposite end defining the free end of the second web. The single length of web may be mounted to the frame between the one end and the opposite end thereof. The apparatus may further comprise a web guide mounted to the frame at or near the top thereof. The single length of web may be slidably received within the web guide between the one end and the opposite end thereof.

Alternatively, the first web may be separate from the second web. The first web may have a mounting end opposite the free end thereof, and the mounting end of the first web may be attached to the frame at or near the top thereof. The second web may also have a mounting end opposite the free end thereof, and the mounting end of the second web may be attached to the frame at or near the top thereof.

The apparatus may further comprise a first arm extending from one side of the frame between base and the top thereof, and a second arm extending from an opposite side of the frame between the base and the top thereof. The first and second arms may contact the cylindrical object between the one end and an opposite end thereof and be configured to restrain sideways movement of the cylindrical object relative to the frame when the cylindrical object is received in the frame. The apparatus may further comprise means for adjusting a distance between the first and second arms to accommodate cylindrical objects of different diameters.

The apparatus may further comprise a web length adjuster configured to adjust a length of the third web.

The frame may comprise at least one opening therethrough for mounting the frame to a support surface in any orientation relative thereto while restraining the cylindrical object within the frame.

The support surface may be part of a motor vehicle. The apparatus may restrain the cylindrical object within the frame when mounted to the support surface in any orientation relative thereto and under all vehicle acceleration conditions including vehicle impact and roll over events.

The apparatus may further comprise means for adjusting a distance between the base and the top of the frame to accommodate cylindrical objects of different length.

The cylindrical object may be a fire extinguisher.

An apparatus for restraining a cylindrical object may comprise a frame having a base configured to receive one end of the cylindrical object and a top opposite the base, a first web mounted to the frame and having a free end extending over at least a portion of an opposite end of the cylindrical object when the cylindrical object is received in the frame, a second web mounted to the frame having a free end extending over at least another portion of the opposite end of the cylindrical object when the cylindrical object is received in the frame, and means for engaging the free ends of the first and second webs with the frame to thereby restrain the cylindrical object relative to the frame.

The frame may comprise a rigid, elongated frame member having a top that defines the top of the frame and a bottom opposite the top of the elongated frame member. The base of the frame may comprise a base member that extends outwardly and away from the bottom of the elongated frame member to a free end thereof. The base member may be configured to receive and support the one end of the cylindrical object when the cylindrical object is received in the frame. The base member may define opposing sides between the elongated frame member and the free end thereof. The apparatus may further comprise a first ear extending upwardly from one of the opposing sides of the base member, and a second ear extending upwardly from the other of the opposing sides of the base member. The first and second ears may be configured to restrain sideways movement of the one end of the cylindrical object relative to the base member when the cylindrical object is received in the frame. The apparatus may further comprise means for adjusting a distance between the first and second ears to accommodate cylindrical objects of different diameters.

The first web and the second web may together comprise a single length of web having one end defining the free end of the first web and an opposite end defining the free end of the second web. The single length of web may be mounted to the frame between the one end and the opposite end thereof. The apparatus may further comprise a web guide mounted to the frame, and the single length of web may be slidably received within the web guide between the one end and the opposite end thereof.

Alternatively, the first web may be separate from the second web. The first web may have a mounting end opposite the free end thereof, and the mounting end of the first web may be attached to the frame. The second web may also have a mounting end opposite the free end thereof, and the mounting end of the second web may be attached to the frame.

The apparatus may further comprise a first arm extending from one side of the frame between base and the top thereof, and a second arm extending from an opposite side of the frame between the base and the top thereof. The first and second arms may be configured to contact the cylindrical object between the one end and an opposite end thereof and configured to restrain sideways movement of the cylindrical object relative to the frame when the cylindrical object is received in the frame. The apparatus may further comprise means for adjusting a distance between the first and second arms to accommodate cylindrical objects of different diameter.

The frame may be configured to be mounted to a support surface in any orientation relative thereto while restraining the cylindrical object within the frame. The support surface may be part of a motor vehicle, and the apparatus may restrain the cylindrical object within the frame when mounted to the support surface in any orientation relative thereto and under all vehicle acceleration conditions including vehicle impact and roll over events.

The apparatus may further comprise means for adjusting a distance between the base and the top of the frame to accommodate cylindrical objects of different length.

The cylindrical object may be a fire extinguisher.

### BRIEF DESCRIPTION OF THE DRAWINGS

FIG. 1 is a front plan view of one illustrative embodiment of an apparatus for restraining a cylindrical object shown with a conventional fire extinguisher positioned behind the apparatus.

FIG. 2 is a magnified view of the bottom portion of the apparatus illustrated in FIG. 1.

FIG. 3 is a magnified view of the top portion of the apparatus illustrated in FIG. 1.

FIG. 4 is a front plan view of the apparatus of FIG. 1 shown with the fire extinguisher partially restrained therein.

FIG. 5 is a perspective view of the apparatus of FIG. 1 shown with the fire extinguisher restrained therein.

FIG. 6 is a front plan view of the apparatus of FIG. 1 shown with the fire extinguisher restrained therein and also with an optional anti-rattle mechanism engaged.

FIG. 7 is a side view of the embodiment illustrated in FIG. 6.

FIG. 8 is a rear view of the embodiment illustrated in FIG. 6.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

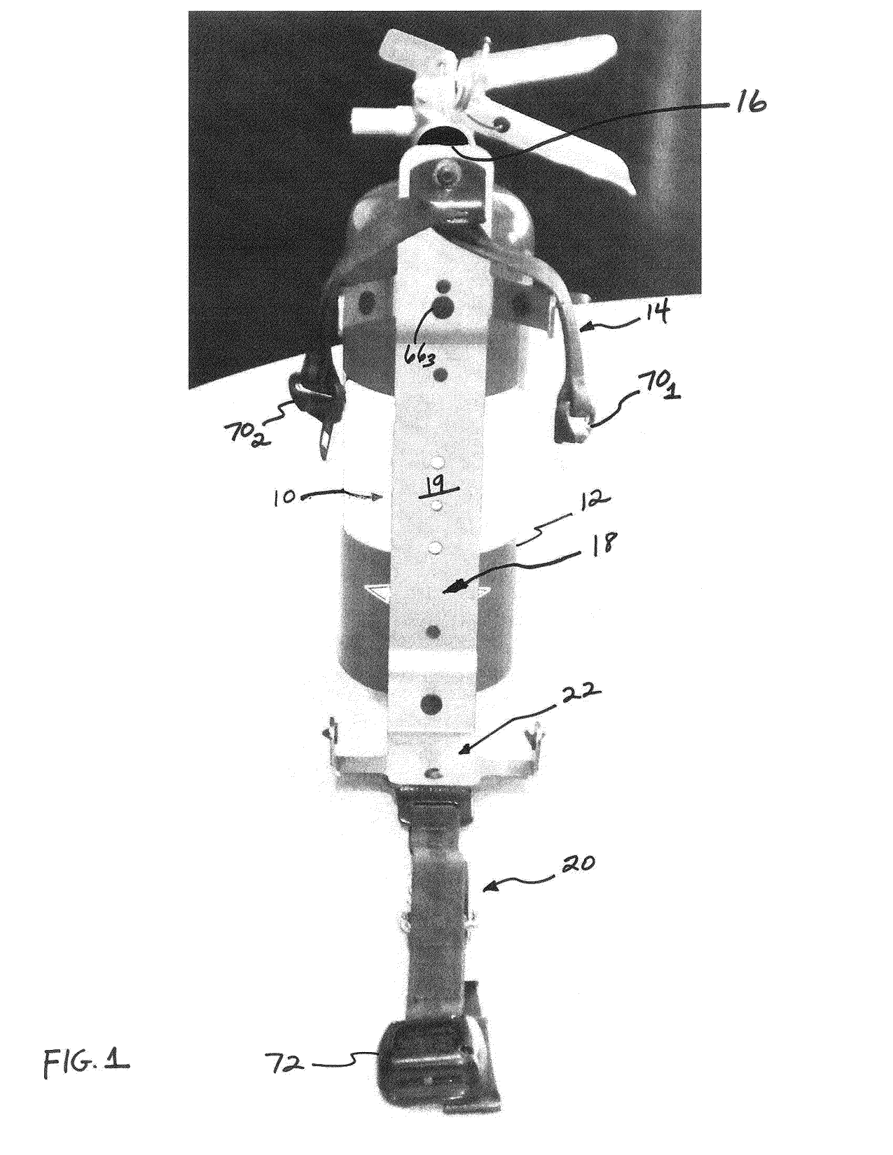

Referring now to FIG. 1, a front plan view is shown of one illustrative embodiment of an apparatus 10 for restraining a cylindrical object 12. In the illustrated embodiment, the cylindrical object 12 is shown positioned behind the apparatus 10, and is illustrated in the form of a conventional fire extinguisher. It will be understood, however, that in alternate embodiments the cylindrical object 12 may be any cylindrical or step-wise cylindrical (e.g., hexagonal, octagonal or other polygon that approximates a generally circular cross-section) object, examples of which include, but should not be limited to, gas tanks, e.g., propane tanks or the like, air tanks for self-contained breathing apparatuses (SCBA) and/or self-contained underwater breathing apparatuses (SCUBA), and the like. As will be discussed in greater detail hereinafter, the apparatus 10 is configured to be mounted to a support structure in any orientation relative thereto, and the support surface may be, for example, but not limited to, an interior, exterior or other part of a motor vehicle. Generally, the apparatus 10 is configured to restrain the cylindrical object 12 therein under all operating conditions of such a motor vehicle including vehicle roll over and impact events. A motor vehicle to which the apparatus 10 may be mounted may be any transportation vehicle configured to transport occupants or goods by land, air or water, and examples include, but should not be limited to, conventional automobiles, trucks, busses, motor coaches, trains, monorail systems, watercrafts, aircrafts, and the like.

In the embodiment illustrated in FIG. 1, the apparatus 10 includes a first web 14 mounted at or near a top 16 of a frame 18, and a second web 20 mounted to a base 22 of the frame 18. Illustratively, the frame 18 includes a rigid, elongated frame member 19, e.g., a flat plate or bar, having a top that defines the top 16 of the frame 18 and a bottom opposite the top 16. The base 22 includes a rigid base member 23, e.g., a flat plate or bar, and extends outwardly and away from the bottom of the elongated frame member 19 along opposite sides 30A and 30B to a free end 30C thereof. In the illustrated embodiment, the frame member 19 and the base member 23 are of unitary construction, although in alternate embodiments the frame member 19 and the base member 23 may be separate components that are suitably joined together. In one illustrative embodiment, the frame member 19 and the base member 22 are formed of steel, although this disclosure contemplates other embodiments in which the frame member 19 and/or the base member 23 may be formed of other materials.

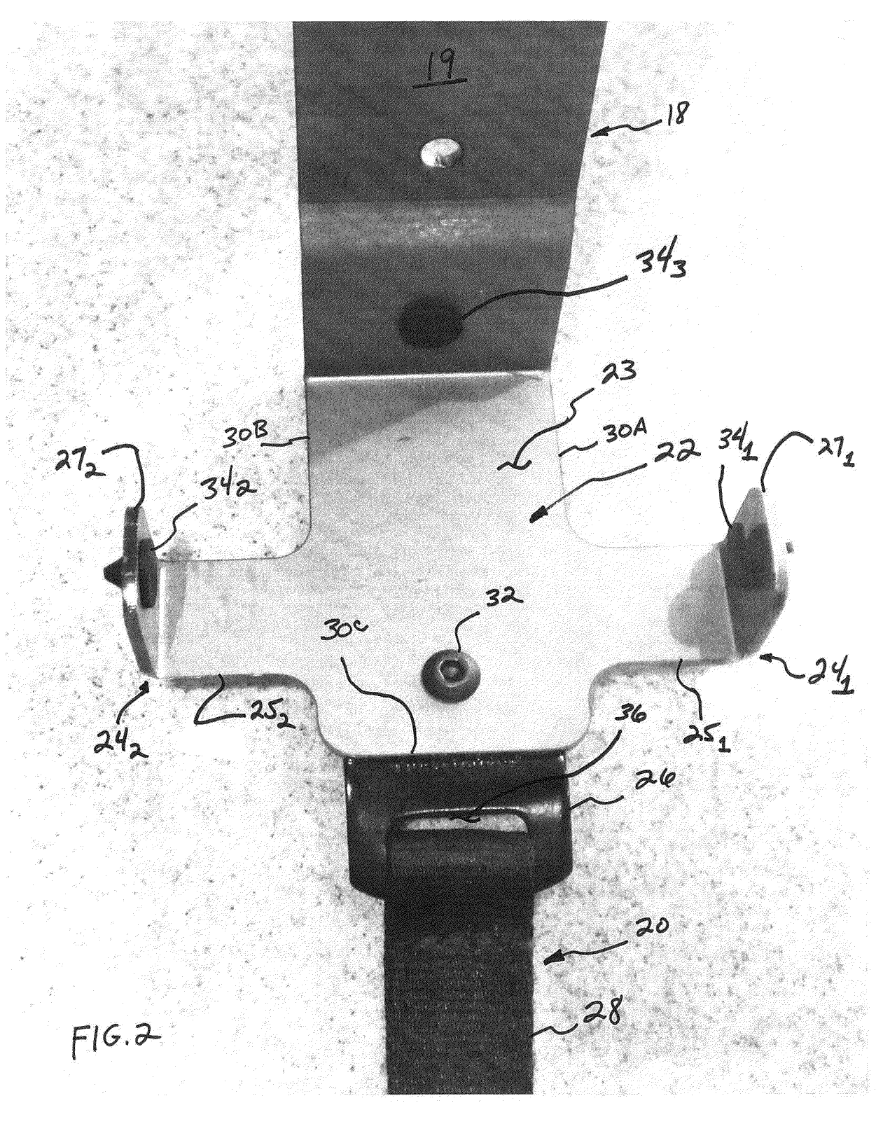

Referring now to FIG. 2, a magnified view of the base 22 of the frame 18 is shown. The base 22 of the frame 18 is generally configured to receive in contact one end of the cylindrical object 12, and in the illustrated embodiment the base member 23 further includes side restraint structures 24₁ and 24₂ extending from corresponding sides 30A and 30B of the base member 23 for the purpose of restraining side portions of the cylindrical object 12 near the base 15A thereof. Illustratively, the side restraint structures 24₁ and 24₂ include corresponding protrusions 25₁ and 25₂ extending from corresponding sides 30A and 30B of the base member 23. The protrusions 25₁ and 25₂ are illustratively flat protrusions each having a top surface that is co-planar with the top surface of the base member 23 such that the top surfaces of the base member 23, the protrusion 25₁ and the protrusion 25₂ form a co-planar surface. In the illustrated embodiment, the protrusions 25₁ and 25₂ are integral with the base member 23, although the protrusions 25₁ and 25₂ may alternatively be separate from the base member 23 and attached thereto via one or more suitable attachment members. Further in the illustrated embodiment, an ear 27₁ extends upwardly and away from the protrusion 25₁, and another ear 27₂ extends upwardly and away from the protrusion 25₂. The upwardly extending ears 27₁ and 27₂ are illustratively configured to restrain sideways movement of the one end 15A of the cylindrical object 12 when the cylindrical object 12 is received in the frame 18.

In the embodiment illustrated in FIG. 2, a number of inserts 34₁-34₃ are mounted to the ears 24₁, 24₂ and the frame member 19 respectively. The inserts 34₁-34₃ are illustratively formed of rubber or other flexible material and provide contact points between the frame 18 and the cylindrical object 12. It will be understood that the base member 23 may further include conventional adjustment mechanisms that provide for adjustment of the distance between the upstanding ears 24₁ and 24₂ to accommodate cylindrical objects 12 of different diameters. As one specific example, each ear 24₁ and 24₂ may include a pair of juxtaposed plates each with aligned slots defined therethrough. In this example, conventional fixation elements, e.g., nut and bolt combination, may be provided through each set of juxtaposed slots to secure each ear 24₁ and 24₂ to the base member 23 and to set the distance between the two ears 24₁ and 24₂. Those skilled in the art will recognize other conventional structures and techniques for providing for adjustability of the distance between the two ears 24₁ and 24₂, and any such other conventional structures and techniques are contemplated by this disclosure.

In the embodiment illustrated in FIG. 2, a web attachment plate 26 is attached, e.g., via a conventional fixation element 32, to the base member 23 at its free end 30. The web attachment plate 26 defines a slot 36 therethrough, and one end of a web member 28 of the web 20 is secured to the web attachment plate 26 through the slot 36. In an alternate embodiment, the slot 36 may be defined through the base member 23 adjacent to the free end 30 thereof, and in this embodiment the web attachment plate 26 may be omitted and the web member 28 of the web 20 may be secured directly to the base member 23 through the slot 36 formed through the base member 23. In any case, a conventional engagement member 74 is attached to the opposite end of the web 20 as illustrated in FIG. 1.

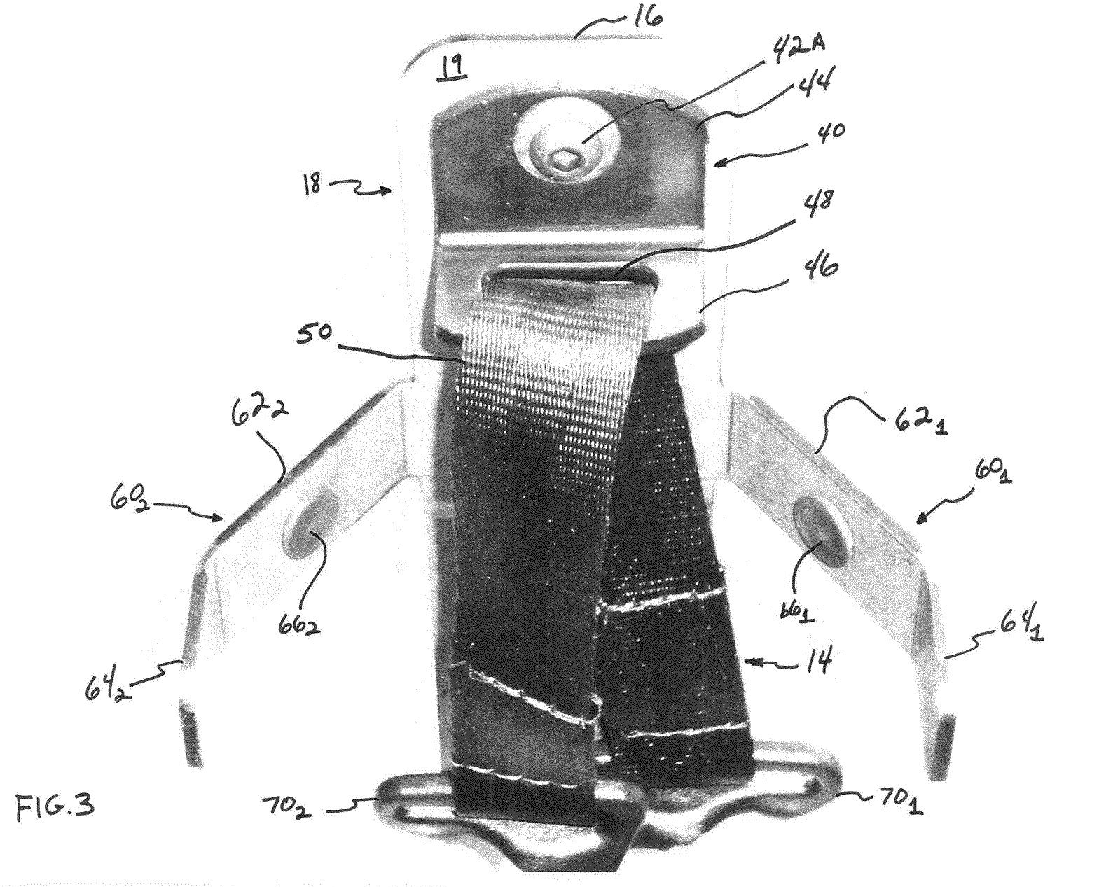

Referring now to FIG. 3, a magnified view of the top 16 of the frame 18 is shown. In the illustrated embodiment, the web 14 is provided in the form of a single length of web 50 having an engagement member 70₁ attached to one thereof and another engagement member 70₂ attached to an opposite end thereof. The single length of web 50 is illustratively mounted to the frame 18 between the opposing ends thereof via a web attachment plate 40 affixed to the frame 18 at or near the top 16 thereof via conventional fixation elements 42A and 42B (fixation element shown in FIG>8). Illustratively, the web attachment plate 40 includes a first portion 44 that lays against and engages the frame 18 and through which the fixation element 42A extends, and a second portion 46 that extends generally perpendicularly away from the first portion 44. The second portion of the web attachment plate 40 defines a slot 48 through which the single length of web 50 is slidably received. In alternative embodiments, the web 14 may be provided in the form of two separate lengths of web each having a mounting end affixed or mounted to the frame 18 at or near the top 16 thereof, and each having a free end having a corresponding one of the engagement members 70₁ and 70₂ attached thereto. In other alternative embodiments in which the web 14 is provided either as a single length of web or as two separate webs, the frame 18 may define a slot at or near the top 16 thereof, and the web 14 may extend through and/or be mounted to the frame 18 via the slot defined at or near the top 16 of the frame 18.

The apparatus 10 further illustratively includes a pair of arms 60₁ and 60₂ extending from opposite sides of the frame member 19 between the bottom and top 16 thereof. In the illustrated embodiment, for example, the arms 60₁ and 60₂ extend from opposite sides of the frame member 19 just below the web attachment plate 40, and each include an angled portion 62₁ and 62₂ respectively connected to one of the sides of the frame member 19 and a straight portion 64₁ and 64₂ respectively that extends generally perpendicularly away from the frame member 19. In the illustrated embodiment, the arms 60₁ and 60₂ are integral with the frame member 19, although this disclosure contemplates embodiments in which the arms 60₁ and 60₂ are separate from and attachable to the frame member 19.

The arms 60₁ and 60₂ are illustratively configured to restrain sideways movement of the cylindrical object 12 when the cylindrical object 12 is received in the frame 18. In the embodiment illustrated in FIG. 3, inserts 66₁ and 66₂ are mounted to the portions 62₁ and 62₂ of the arms 60₁ and 60₂ respectively, and another insert 66₃ is mounted to the frame member 19 in-line with the inserts 66₁ and 66₂ (see FIG. 1). The inserts 66₁-66₃ are illustratively formed of rubber or other flexible material and provide contact points between the arms 60₁ and 60₂ and the cylindrical object 12 when the cylindrical object 12 is received in the frame 18. It will be understood that the arms 60₁ and 60₂ may further include conventional adjustment mechanisms that provide for adjustment of the distance between the arms 60₁ and 60₂ to accommodate cylindrical objects 12 of different diameters. As one specific example, each arm 60₁ and 60₂ may include a pair of juxtaposed plates each with aligned slots defined therethrough. In this example, conventional fixation elements, e.g., nut and bolt combination, may be provided through each set of juxtaposed slots to secure such plates together to set the distance between the two arms 60₁ and 60₂. Those skilled in the art will recognize other conventional structures and techniques for providing for adjustability of the distance between the two arms 60₁ and 60₂, and any such other conventional structures and techniques are contemplated by this disclosure.

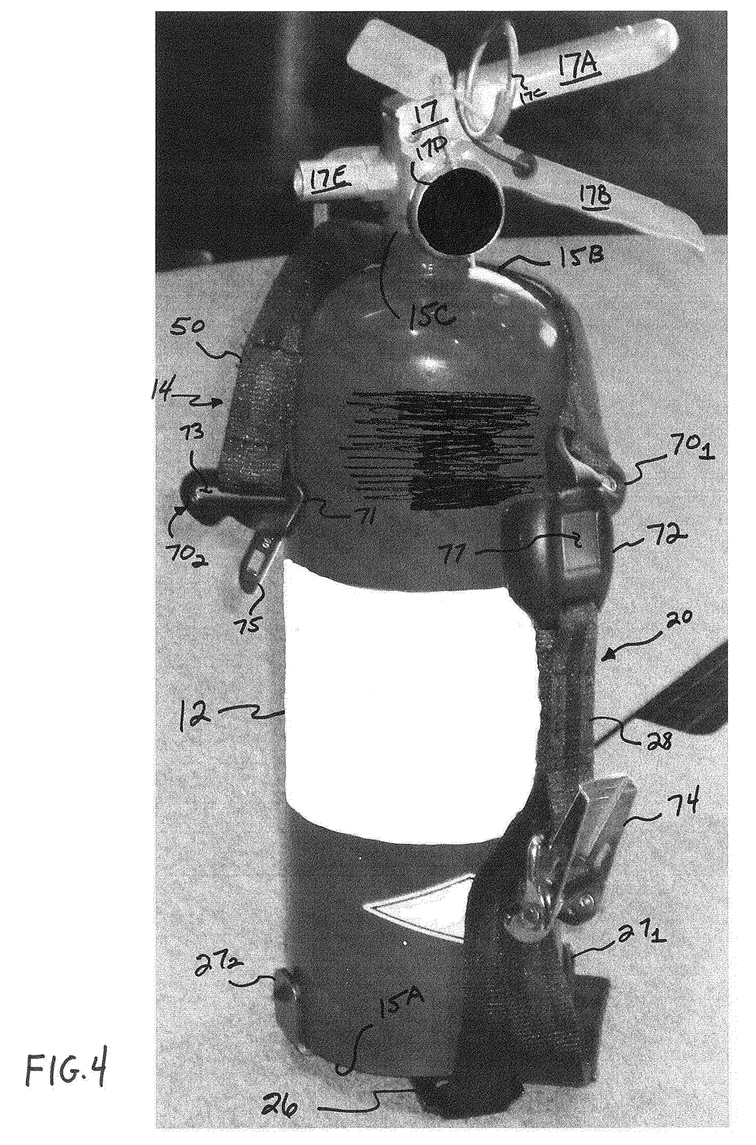

Referring now to FIGS. 4-8, a perspective, side, front opposite side and rear views respectively of the apparatus 10 are shown with the cylindrical object 12 received therein. The cylindrical object 12 defines a bottom end 15A, an opposite top end 15B and a product exit port 15C formed centrally at the top end 15B. In the illustrated embodiment, the cylindrical object 12 is a conventional fire extinguisher carrying a pressurized fire extinguishing product. A conventional product extraction mechanism 17 is fluidly coupled to the product extraction port 15C of the cylindrical object 12, and includes opposing handles 17A and 17B, a handle locking pin 17C, a pressure gauge 17D and a product extraction port 17E. The product extraction mechanisms 17 functions in a conventional manner in that fire extinguishing product is expelled from the fire extinguisher by first removing the locking pin 17C and then forcing the handles 17A and 17B together to expel the fire extinguishing product from the product extraction port 17E.

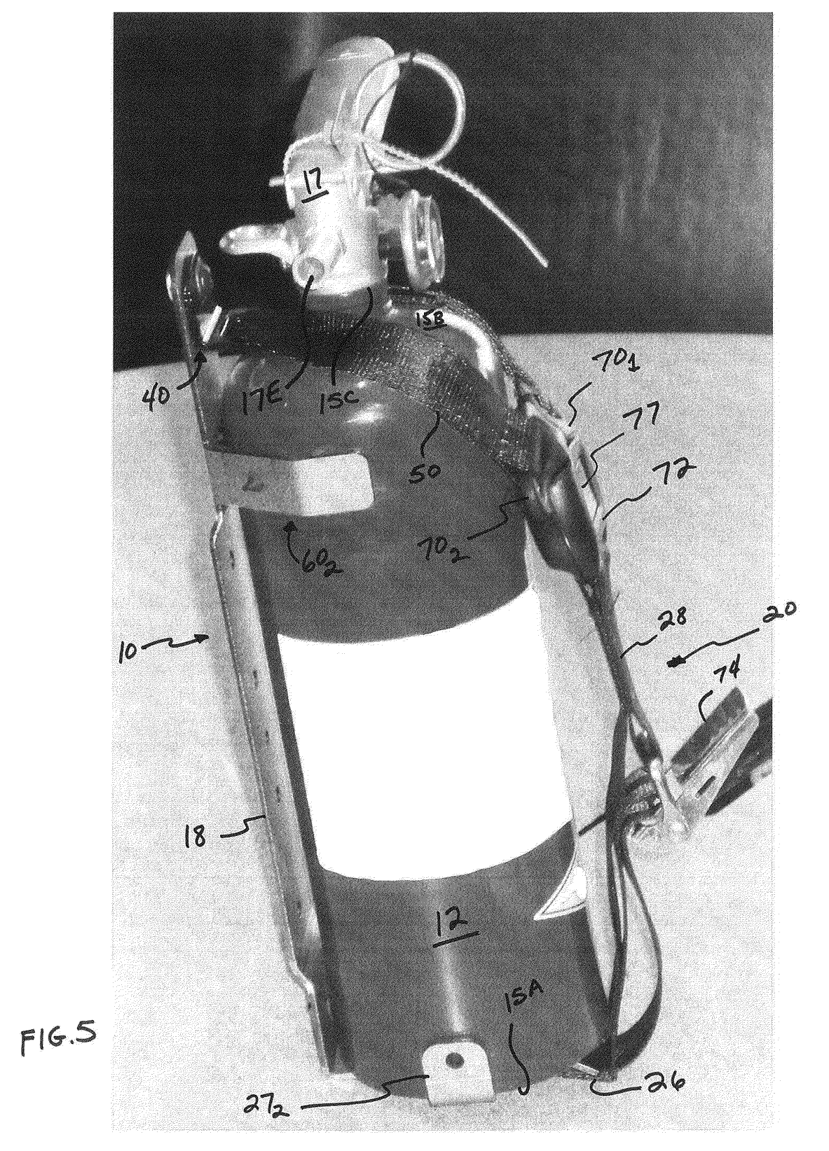

The free ends of the web 14 are configured to extend over different portions of the top 15B of the cylindrical object 12, e.g., on either side of the fluid exit port 15C, when the cylindrical object 12 is received within the frame 18 as shown. In the embodiment illustrated in FIG. 4, the engagement member 70₁ is shown engaged with the engagement member 72, and in the embodiment illustrated in FIG. 5 the engagement member 70₂ is likewise shown engaged with the engagement member 72 to thereby restrain the cylindrical object 12 in the apparatus 10. The engagement members 70₁, 70₂ and 72 are illustratively conventional engagement members in which the engagement members 70₁ and 70₂ each include conventional tongue structures. In FIG. 4, for example, the engagement member 70₂ is illustrated as including a web engagement member 71 defining a slot 73 therethrough, and a conventional tongue 75 extending from the web engagement member 71. The slot 73 is sized to receive and engage the web 14. The engagement member 70₁ is configured in like manner. The engagement member 72, in the illustrated embodiment, is a conventional buckle structure having a central release mechanism 77, and the engagement members 70₁ and 70₂ are each configured to be releasably engaged with the engagement member 72. Alternatively, the engagement members 70₁ and 70₂ may each be provided in the form of conventional buckle structures and the engagement member 72 may be provided with tongue structures configured to releasably engage each of the buckle structures 70₁ and 70₂. It will be understood that one or more other conventional engagement structures may alternatively be used to releasably engage the webs 14 and 20, and that any such one or more other conventional engagement structures are contemplated by this disclosure.

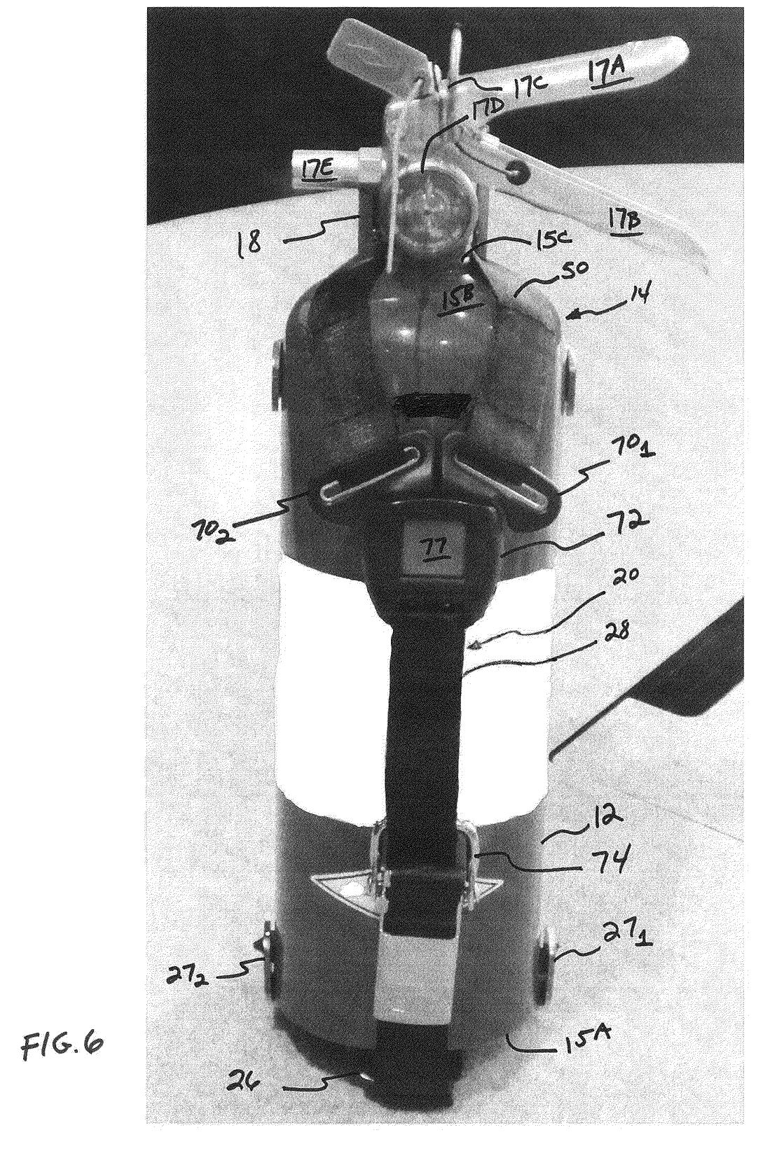

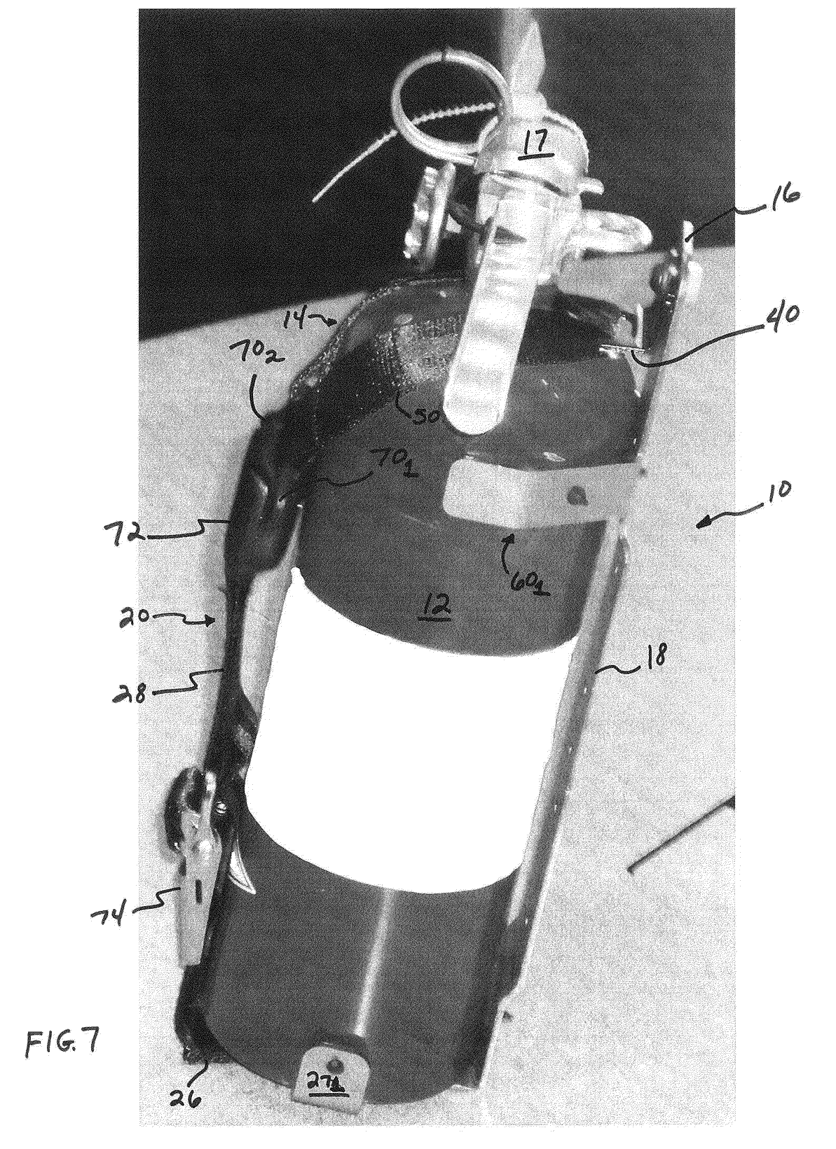

The apparatus 10 may optionally include a web length adjuster 74, e.g., a conventional ratchet device, attached to the web 20. In embodiments that include the web length adjuster device 74, it may be manipulated in a conventional manner to adjust the length of the web 20. In FIGS. 4 and 5, for example, the web length adjuster 74 is released to provide slack, i.e., extra length in the web 20, and in FIGS. 6 and 7 the web length adjuster 74 is actuated to tighten, i.e., make shorter, the web 20. The web length adjuster 74 may thus be used to loosen the webs 14 and 20 to facilitate removal of the cylindrical object 12 from the apparatus 10, e.g., via actuation of the buckle 72, and to tighten the webs 14 and 20 after the cylindrical object 12 is received in the frame 18 and the engagement members 70₁, 70₂ and 72 are engaged. It will be appreciated that while the web length adjuster 74 is not required for operation of the apparatus 10, it eliminates or at least reduces rattle that may otherwise occur between the cylindrical object and one or more of the engagement members 70₁, 70₂ and 72. It will be understood that while the web length adjuster 74 illustrated in the attached figures is provided in the form of a conventional web ratchet device, this disclosure contemplates that the web length adjuster 74 may alternatively be provided in the form of one or more other conventional web length adjusting devices.

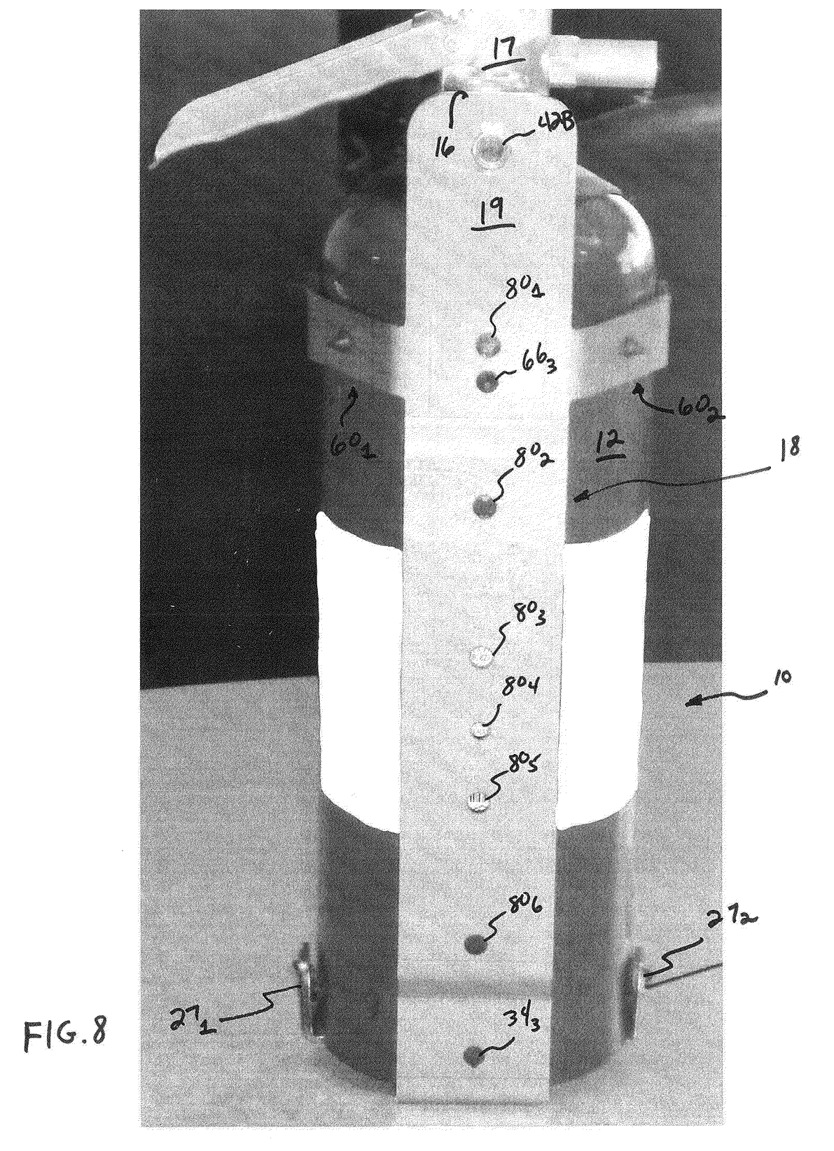

As most clearly illustrated in FIG. 8, the frame member 19 defines a number of openings 80₁-80₆, and any one or combinations of these openings may be used to mount the apparatus 10 to a support surface. One or more conventional fixation elements, e.g., screws or bolts, may, for example, be extended through one or more corresponding ones of the openings 80₁-80₆ and into the support surface to mount the apparatus 10 to the support surface in any orientation relative thereto.

It will be understood that the frame member 19 may further include one or more conventional adjustment mechanisms that provide for adjustment of the distance between the top 16 of the frame member 19 and the base 22 of the frame 18 to accommodate cylindrical objects 12 of different lengths. As one specific example, the frame member 19 may include a pair of juxtaposed plates each with aligned slots defined therethrough. In this example, conventional fixation elements, e.g., nut and bolt combination, may be provided through each set of juxtaposed slots to secure such plates together to set the distance between the top 16 of the frame member 19 and the base 22 of the frame 18. Those skilled in the art will recognize other conventional structures and techniques for providing for adjustability of the distance between the top 16 of the frame member 19 and the base 22 of the frame 18, and any such other conventional structures and techniques are contemplated by this disclosure.

It will be understood that while the apparatus 10 has been illustrated and described herein as including the webs 14 and 20 connected to the frame 18 and engageable with each other, this disclosure contemplates alternate embodiments that may include more, fewer and/or differently arranged webs and/or engagement members. In one alternative embodiment, for example, the web 20 may be omitted and the engagement member 72 may be mounted directly to the base 22 of the frame 18. In this embodiment, the length(s) of the web 14 will be selected to allow engagement of the engagement members 70₁ and 70₂ with the engagement member 72. The web 14 may further include one or more conventional web length adjusters configured to adjust the length of the web(s) 14. This embodiment may further include one or more engagement members attached to the web(s) 14 along its/their length such that the two lands of the web 14 may be laterally engaged at one or more locations along their length.

In another alternative embodiment, the web 14 may be mounted to the frame at or near the base 22 thereof and the engagement member 72 may be mounted via a web or directly to the frame member 19 at or near the top 16 thereof. In this embodiment, the length(s) of the web 14 will be selected to allow engagement of the engagement members 70₁ and 70₂ with the engagement member 72. The web 14 may further include one or more conventional web length adjusters configured to adjust the length of the web(s) 14. This embodiment may further include one or more engagement members attached to the web(s) 14 along its/their length such that the two lands of the web 14 may be laterally engaged at one or more locations along their length.

In yet another alternative embodiment, the web 20 may be omitted and the free ends of the web 14 may be attached to the frame 18 at or near the base 22 thereof. In this embodiment, the web 14 will include one or more conventional engagement members attached to the web(s) 14 along its/their length such that the two lands of the web 14 may be laterally engaged at one or more locations along their length.

In still another embodiment, the web 14 and/or the web 20 may be extend into one or more conventional retractors suitably mounted to the frame 18. In this embodiment, the web 14 and/or the web 20 would pay out from the one or more retractors and engage each other or the frame as described with respect to any of the foregoing embodiments. Illustratively, the one or more retractors may be conventional inertial locking retractors to ensure restraining of the cylindrical object within the frame 18 under adverse vehicle acceleration conditions such as, for example, but not limited to, vehicle impact and vehicle rollover events.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. An apparatus for restraining a cylindrical object, the apparatus comprising:
a frame having a base configured to receive in contact one end of the cylindrical object and a top opposite the base,
a first web mounted to the frame at or near the top thereof and having a free end extending over at least a portion of an opposite end of the cylindrical object when the cylindrical object is received in the frame,
a second web mounted to the frame at or near the top thereof and having a free end extending over at least another portion of the opposite end of the cylindrical object when the cylindrical object is received in the frame,
a third web mounted to the frame at or near the base thereof and having a free end, and
means for releasably engaging the free ends of the first, second and third webs to thereby restrain the cylindrical object relative to the frame.

2. The apparatus of claim 1 wherein the frame comprises a rigid, elongated frame member having a top that defines the top of the frame and a bottom opposite the top of the elongated frame member,
and wherein the base of the frame comprises a base member that extends outwardly and away from the bottom of the elongated frame member to a free end thereof, the base member configured to receive in contact the one end of the cylindrical object when the cylindrical object is received in the frame.

3. The apparatus of claim 2 wherein the base member defines opposing sides between the elongated frame member and the free end thereof, and further comprising:
a first ear extending upwardly from one of the opposing sides of the base member, and
a second ear extending upwardly from the other of the opposing sides of the base member, the first and second ears configured to restrain sideways movement of the one end of the cylindrical object relative to the base member when the cylindrical object is received in the frame.

4. The apparatus of claim 3 further comprising means for adjusting a distance between the first and second ears to accommodate cylindrical objects of different diameters.

5. The apparatus of claim 1 wherein the first web and the second web together comprise a single length of web having one end defining the free end of the first web and an opposite end defining the free end of the second web, the single length of web mounted to the frame between the one end and the opposite end thereof.

6. The apparatus of claim 5 further comprising a web guide mounted to the frame at or near the top thereof,
wherein the single length of web is slidably received within the web guide between the one end and the opposite end thereof.

7. The apparatus of claim 1 wherein the first web is separate from the second web,
and wherein the first web has a mounting end opposite the free end thereof, and the mounting end of the first web is attached to the frame at or near the top thereof,
and wherein the second web has a mounting end opposite the free end thereof, and the mounting end of the second web is attached to the frame at or near the top thereof.

8. The apparatus of claim 1 further comprising:
a first arm extending from one side of the frame between base and the top thereof, and
a second arm extending from an opposite side of the frame between the base and the top thereof, the first and second arms contacting the cylindrical object between the one end and an opposite end thereof and be configured to restrain sideways movement of the cylindrical object relative to the frame when the cylindrical object is received in the frame.

9. The apparatus of claim 8 further comprising means for adjusting a distance between the first and second arms to accommodate cylindrical objects of different diameters.

10. The apparatus of claim 1 further comprising a web length adjuster configured to adjust a length of the third web.

11. The apparatus of claim 1 wherein the frame comprises at least one opening therethrough for mounting the frame to a support surface in any orientation relative thereto while restraining the cylindrical object within the frame.

12. The apparatus of claim 11 wherein the support surface is part of a motor vehicle,
and wherein the apparatus restrains the cylindrical object within the frame when mounted to the support surface in any orientation relative thereto and under all vehicle acceleration conditions including vehicle impact and roll over events.

13. The apparatus of claim 1 further comprising means for adjusting a distance between the base and the top of the frame to accommodate cylindrical objects of different length.

14. An apparatus for restraining a cylindrical object, the apparatus comprising:
a frame having a base configured to receive one end of the cylindrical object and a top opposite the base,
a first web mounted to the frame and having a free end extending over at least a portion of an opposite end of the cylindrical object when the cylindrical object is received in the frame,
a second web mounted to the frame having a free end extending over at least another portion of the opposite end of the cylindrical object when the cylindrical object is received in the frame, and
means for engaging the free ends of the first and second webs with the frame to thereby restrain the cylindrical object relative to the frame.

15. The apparatus of claim 14 wherein the frame comprises a rigid, elongated frame member having a top that defines the top of the frame and a bottom opposite the top of the elongated frame member,
and wherein the base of the frame comprises a base member that extends outwardly and away from the bottom of the elongated frame member to a free end thereof, the base member configured to receive and support the one end of the cylindrical object when the cylindrical object is received in the frame.

16. The apparatus of claim 15 wherein the base member defines opposing sides between the elongated frame member and the free end thereof, and further comprising:
a first ear extending upwardly from one of the opposing sides of the base member, and
a second ear extending upwardly from the other of the opposing sides of the base member, the first and second ears configured to restrain sideways movement of the one end of the cylindrical object relative to the base member when the cylindrical object is received in the frame.

17. The apparatus of claim 16 further comprising means for adjusting a distance between the first and second ears to accommodate cylindrical objects of different diameters.

18. The apparatus of claim 14 wherein the first web and the second web together comprise a single length of web having one end defining the free end of the first web and an opposite end defining the free end of the second web, the single length of web mounted to the frame between the one end and the opposite end thereof.

19. The apparatus of claim 18 further comprising a web guide mounted to the frame,
wherein the single length of web is slidably received within the web guide between the one end and the opposite end thereof.

20. The apparatus of claim 14 wherein the first web is separate from the second web,
and wherein the first web has a mounting end opposite the free end thereof, and the mounting end of the first web is attached to the frame,
and wherein the second web has a mounting end opposite the free end thereof, and the mounting end of the second web is attached to the frame.

21. The apparatus of claim 14 further comprising:
a first arm extending from one side of the frame between base and the top thereof, and
a second arm extending from an opposite side of the frame between the base and the top thereof, the first and second arms configured to contact the cylindrical object between the one end and an opposite end thereof and configured to restrain sideways movement of the cylindrical object relative to the frame when the cylindrical object is received in the frame.

22. The apparatus of claim 21 further comprising means for adjusting a distance between the first and second arms to accommodate cylindrical objects of different diameter.

23. The apparatus of claim 14 wherein the frame is configured to be mounted to a support surface in any orientation relative thereto while restraining the cylindrical object within the frame.

24. The apparatus of claim 23 wherein the support surface is part of a motor vehicle,
and wherein the apparatus restrains the cylindrical object within the frame when mounted to the support surface in any orientation relative thereto and under all vehicle acceleration conditions including vehicle impact and roll over events.

25. The apparatus of claim 14 further comprising means for adjusting a distance between the base and the top of the frame to accommodate cylindrical objects of different length.

26. The apparatus of claim 1 wherein the cylindrical object is a fire extinguisher.

27. The apparatus of claim 14 wherein the cylindrical object is a fire extinguisher.
